(19) United States
(12) Patent Application Publication
(10) Pub. No.: US 2022/0383477 A1
(43) Pub. Date: Dec. 1, 2022

(54) COMPUTER-READABLE RECORDING MEDIUM HAVING STORED THEREIN EVALUATION PROGRAM, EVALUATION METHOD, AND INFORMATION PROCESSING APPARATUS

(71) Applicant: FUJITSU LIMITED, Kawasaki-shi (JP)

(72) Inventors: Masataka Umeda, Kawasaki (JP); Yoshimasa MISHUKU, Yokohama (JP)

(73) Assignee: FUJITSU LIMITED, Kawasaki-shi (JP)

(21) Appl. No.: 17/692,085

(22) Filed: Mar. 10, 2022

(30) Foreign Application Priority Data
May 28, 2021 (JP) 2021-090403

(51) Int. Cl. G06T 7/00; G06V 10/774; G06V 10/40; G06V 10/764; G06V 10/22; G06V 10/82; G06T 7/62; G06T 7/73

(52) U.S. Cl. CPC G06T 7/0002; G06V 10/7747; G06V 10/40; G06V 10/764; G06V 10/22; G06V 10/82; G06T 7/62; G06T 7/73; G06V 2201/07; G06T 2207/20084; G06T 2207/20081

(57) ABSTRACT

A non-transitory computer-readable recording medium having stored therein an evaluation program for causing a computer to execute a process including: specifying a plurality of partial images included in input image data by inputting the input image data into a detection model, the detection model being a machine learning model trained with a first training data set including a plurality of first training data each associating image data with a partial image which contains an extraction target from the image data; and evaluating the input image data by inputting the plurality of specified partial images into an evaluation model, the evaluation model being a machine learning model trained with a second training data set including a plurality of second training data each associating one or more partial images with an evaluation result of a target being a subject of an image containing the one or more partial images.

### CROSS-REFERENCE TO RELATED APPLICATION

This application is based upon and claims the benefit of priority of the prior Japanese Patent application No. 2021-090403, filed on May 28, 2021, the entire contents of which are incorporated herein by reference.

### FIELD

The embodiment discussed herein is directed to a computer-readable recording medium having stored therein an evaluation program, an evaluation method, and an information processing apparatus.

### BACKGROUND

Cosmetic inspection has been known which confirms defects in appearance, such as foreign matter, stains, scratches, burrs, chipping, and deformation adhering to or occurring on a surface of a component or product and evaluates the component or the product by means of quality determination, for example.

One of the known methods of cosmetic inspection is a blob analysis for performing an image analysis on blobs. A blob means a block, and a blob in an image analysis means, for example, an individual region formed of pixels in one value (in other words “color”) in a binarized image.

Cosmetic inspection such as blob analysis may be performed in, for example, an image analysis process using Artificial Intelligence (AI) by a computer. For example, the computer carries out the quality determination on a blob by using a machine learning model generated on the basis of images obtained by photographing images of a component or product to be inspected.
[Patent Document 1] Japanese Laid-Open Patent Publication No. 2020-153764

### SUMMARY

According to an aspect of the embodiments, a non-transitory computer-readable recording medium having stored therein an evaluation program for causing a computer to execute a process including: specifying a plurality of partial images included in input image data by inputting the input image data into a detection model, the detection model being a machine learning model trained with a first training data set including a plurality of first training data each associating image data with a partial image which contains an extraction target from the image data; and evaluating the input image data by inputting the plurality of specified partial images into an evaluation model, the evaluation model being a machine learning model trained with a second training data set including a plurality of second training data each associating one or more partial images with an evaluation result of a target being a subject of an image containing the one or more partial images.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the functional configuration of a server according to one embodiment;

FIG. 2 is a diagram illustrating an example of a detection model training data set;

FIG. 3 is a diagram illustrating an example of a photographed image;

FIG. 4 is a diagram illustrating an example of a machine learning process of a detection model;

FIG. 5 is a diagram illustrating an example of an analysis model training data set;

FIG. 6 is a diagram illustrating an example of a machine learning process of an analysis model;

FIG. 7 is a diagram illustrating an example of an analysis model training data set when a machine learning on an analysis mode is carried out;

FIG. 8 is a diagram illustrating an example of an inferring process performed by an executing unit;

FIG. 9 is a flow diagram illustrating an example of an operation of a machine learning process of a detection model;

FIG. 10 is a flow diagram illustrating an example of an operation of a machine learning process of an analysis model;

FIG. 11 is a flow diagram illustrating an example of an operation of a blob extracting process;

FIG. 12 is a flow diagram illustrating an example of an operation of an inferring process;

FIG. 13 illustrates an example of a photographed image of a sheet containing a fisheye as a defect;

FIG. 14 is a diagram illustrating an example of machine learning of a neural network not including a set operation;

FIG. 15 is a diagram illustrating examples of a blob image, a feature value, and an inference result (quality determination result); and

FIG. 16 is a diagram illustrating an example of a hardware configuration of a computer that achieves the function of a server according to one embodiment.

### DESCRIPTION OF EMBODIMENT(S)

If the size of a component or product to be inspected is large, the image of the component or product is sometimes photographed at a high resolution in order to record (include) possible cosmetic defects in the image in the cosmetic inspection. However, in a high resolution image, the size of a defect may become extremely small relative to the image size.

In addition, the size of a defect, the shape of a component or product, and the like may be different with an inspection item. In addition, the criteria of the quality determination may be different. However, in generation of a machine learning model, the condition such as the size, shape, number of blobs and the purpose and the requirements of the inspection are not sometimes considered, which makes it difficult to carry out the quality determination of the entire target, such as a component or product.

Furthermore, in a blob analysis by a computer using machine learning, quality determination may be made on each individual blob, but it may be difficult to make quality determination in units of an image including one or more blobs or in units of a product.

As described above, in some cases, a computer has a difficulty in carrying out cosmetic inspection based on a photographed image by means of machine learning.

Hereinafter, an embodiment of the present invention will now be described with reference to the accompanying drawings. However, the embodiment described below is merely illustrative and there is no intention to exclude the application of various modifications and techniques that are not explicitly described below. For example, the present embodiment can be variously modified and implemented without departing from the scope thereof. In the drawings to be used in the following description, like reference numbers denote the same or similar parts, unless otherwise specified.

### (1) One Embodiment

### (1-1) Example of Functional Configuration of Server

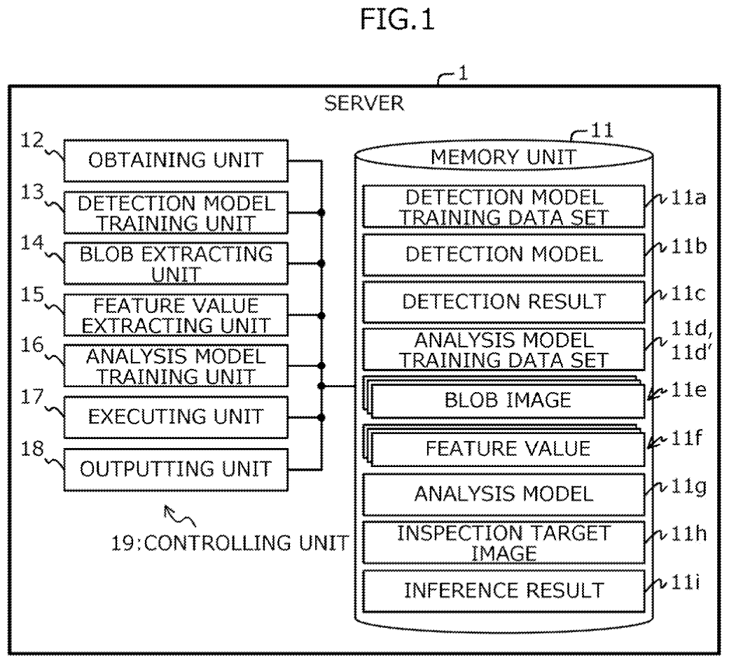

FIG. 1 is a block diagram illustrating an example of a functional configuration of a server 1 as an example of one embodiment. The server 1 is an example of an evaluating apparatus or an information processing apparatus that evaluates input image data.

As illustrated in FIG. 1, the server 1 may illustratively include a memory unit 11, an obtaining unit 12, a detection model training unit 13, a blob extracting unit 14, a feature value extracting unit 15, an analysis model training unit 16, an executing unit 17, and an outputting unit 18. The obtaining unit 12, the detection model training unit 13, the blob extracting unit 14, the feature value extracting unit 15, the analysis model training unit 16, the executing unit 17, and the outputting unit 18 are examples of a controlling unit 19.

The memory unit 11 is an example of a storage region and stores various kinds of information used for processing performed by the server 1. As illustrated in FIG. 1, the memory unit 11 may illustratively be capable of storing a detection model training data set 11a, a detection model lib, a detection result 11c, an analysis model training data set 11d and 11d′, multiple blob images 11e, multiple feature values 11f, an analysis model 11g, an inspection target image 11h, an inference result 11i, and outputting data.

The obtaining unit 12 obtains at least a part of information used for execution of a machine learning process (training) of each of the detection model 11b and the analysis model 11g, and an inferring process using the trained detection model 11b and the trained analysis model 11g from a computer (not illustrated), for example.

For example, the obtaining unit 12 may obtain the detection model training data set 11a and the analysis model training data set 11d used for machine learning the detection model 11b and the analysis model 11g, respectively, and the inspection target images 11h used for an inferring process, and store them into the memory unit 11.

The detection model training data set 11a is an example of a training data including a plurality (e.g., collection) of training data each associating image data with a partial image which contains an extraction target from the image data. The image data is assumed to be image data (image) obtained by photographing an inspection target, for example, a target of a cosmetic inspection, and is exemplified by a photographed image of the appearance of the target. The target is an object (subject) to be inspected.

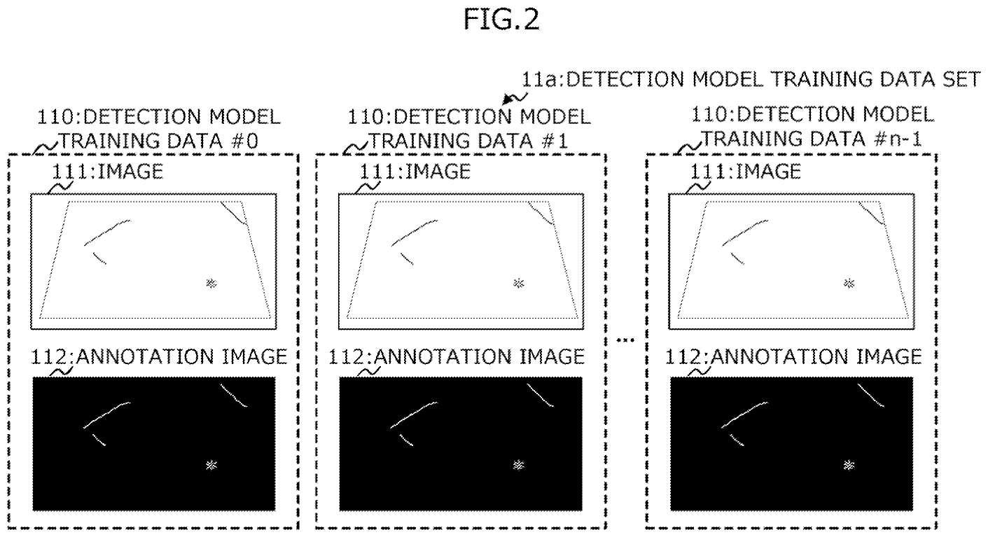

FIG. 2 is a diagram illustrating an example of the detection model training data set 11a. As illustrated in FIG. 2, the detection model training data set 11a may be a collection of n (n is an integer of two or more) pieces of detection model training data 110 (detection model training data #0 to #n−1). Each detection model training data 110 is an example of first training data, and may include an image 111 obtained by photographing a target of training (which may be referred to as a “training target”) and an annotation image 112 representing a partial image of an extraction target in the training target from the image 111 in association with each other.

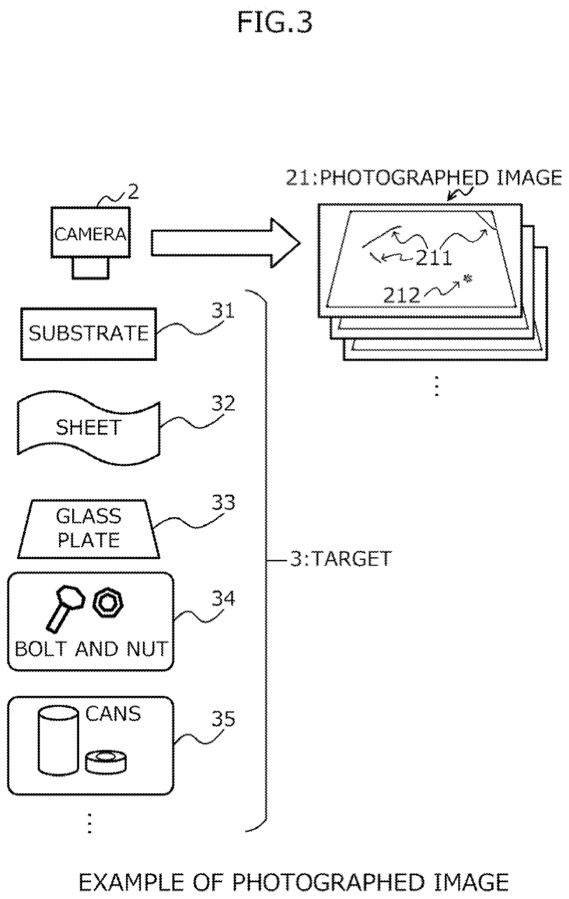

Each image 111 is an example of image data. As illustrated in FIG. 3, the image 111 is exemplified by a photographed image 21 obtained by photographing the appearance of at least one target (training target) 3 with a camera 2 serving as an example of an imaging device. For example, the obtaining unit 12 may obtain (e.g., receive) the photographed image 21 captured with the camera 2 from the camera 2 or the computer via a non-illustrated network.

In the following description, it is assumed that the “image” or “photographed image” including image 111, an image 121 to be detailed below and an inspection target image 11h to be detailed below correspond to the photographed image 21 captured in the method of FIG. 3. The target 3 includes, for example, at least one kind of various products or components such as a substrate 31, a sheet 32, a glass plate 33, bolt and nut 34, and cans 35.

Each image 111 in multiple detection model training data 110 may be a frame chronologically (e.g., t=0 to (n−1)) cut out from a series of moving images captured by the camera 2, or may be a frame cut out from moving images different from each other. Alternatively, each image 111 may be an image photographed as a still image.

The annotation image 112 is an example of annotation data, and for example, is an image illustrating an annotation in units of a pixel of the extraction target in the image 111, as illustrated in FIG. 2. The extraction target may be, for example, a binary image (binarized image) in which a blob region related to the quality determination (evaluation) is represented by white (or black) and a region except for the blob region is represented by black (or white). A blob region may be, for example, a defect region indicating a defective portion in the appearance of a component or product as the object 3.

Examples of a “defect” include at least one of foreign matter, stain, scratch, burr, chipping, and deformation, and the like adhering to or occurring on a surface of a component or product. FIG. 3 illustrates a scratch 211 and a stain 212 as a defect of the target 3 in the photographed image 21.

The annotation image 112 may be generated, for example, by an image processing (image analysis) using a computer, may be generated by a user, or may be generated by various other methods.

The detection model training unit 13 machine-learns the detection model 11b using each of multiple detection model training data 110 included in the detection model training data set 11a.

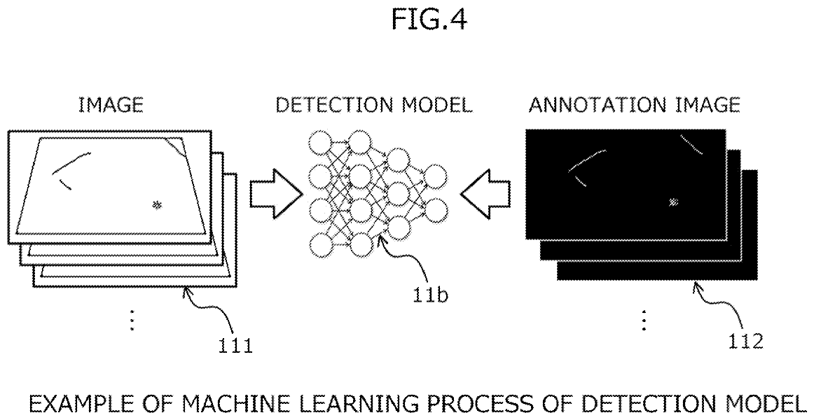

FIG. 4 is a diagram illustrating an example of a machine learning process on the detection model lib. As illustrated in FIG. 4, the detection model training unit 13 machine-learns (trains) an Artificial Intelligence (AI) model with respect to pairs of the image 111 and the annotation image 112 included in the respective detection model training data 110, using the images 111 captured by photographing the target 3 as inputting data and also using the annotation images 112 representing a defect region in the images 111 as teaching information (label data). The AI model becomes available as the detection model 11b upon completion of the machine learning. The detection model 11b is, for example, various neural networks (NNs) for detecting a blob, and is exemplified by a NN for segmentation.

The example of FIG. 4 assumes that the photographing conditions for the multiple images 111 included in the detection model training data 110 are the same. An example of a case where the photographing conditions are the same is a case where the images 111 are continuously photographed with the camera 2 installed on the line in the factory. This makes it possible to eliminate or reduce a variation in resolution of the images 111 and/or in size of a region of a component or product in the images 111, and the like among the images 111.

Since the one embodiment assumes that the photographing condition is the same, the detection model 11b can be appropriately trained even if the teaching information does not include information about differences in the photographing condition for each image 111 as a label. On the other hand, under a state where the images 111 are photographed under a varying photographing condition, the detection model training unit 13 may additionally provide a label that can absorb the difference in photographing condition as the teaching information in the machine learning process. An example of such a label may include a label related to the size of the entire image 111 (or the entire part of a component or product appearing in the image 111).

The blob extracting unit 14 executes a blob extracting process that extracts a blob image 11e to be used in the machine learning process of the analysis model 11g and the inferring process using the analysis model 11g from an output result (inference result) from the detection model lib.

For example, the blob extracting unit 14 may input an image included in the analysis model training data set 11d into the detection model 11b trained by the detection model training unit 13 and execute the blob extracting process on a binary image of the inference result output from the detection model lib.

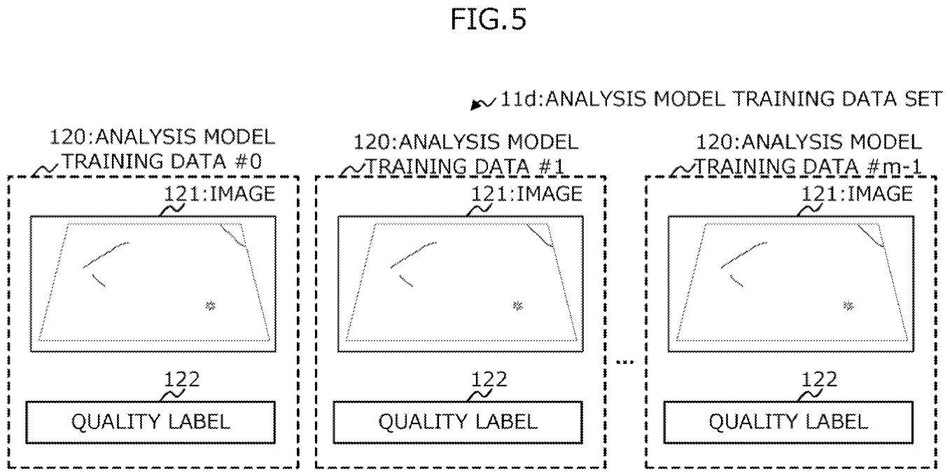

FIG. 5 is a diagram illustrating an example of the analysis model training data set 11d. As illustrated in FIG. 5, the analysis model training data set 11d may be a collection of m (m is an integer of two or more) analysis model training data 120 (analysis model training data #0 to #m−1). Each analysis model training data 120 is an example of the second training data, and may include an image 121 obtained by photographing the target 3 and a quality label 122 indicating whether each image 121 is determined to be good or bad in the quality determination in association with each other.

An example of the images 121 is photographed images 21 illustrated in FIG. 3. The images 121 may be the same as (common to) or different from the images 111 included in the detection model training data set 11a.

The quality label 122 is an example of an evaluation result of the target 3 which is the subject of the image 121, and may be, for example, information indicating whether the target 3 is determined to be a “defective product” or a “non-defective product” in quality determination based on the image 121. The quality label 122 may be a numerical value of “1” or “0” as an example. For example, the quality label 122 of “1” may indicate that the target 3 is determined to be a defective product in the quality determination, and the quality label 122 of “0” may indicate that the target 3 is determined to be a non-defective product in the quality determination. The quality label 122 may be associated with a corresponding image 121, for example, in accordance with a quality determination result of the image 121, or may be set by various other methods.

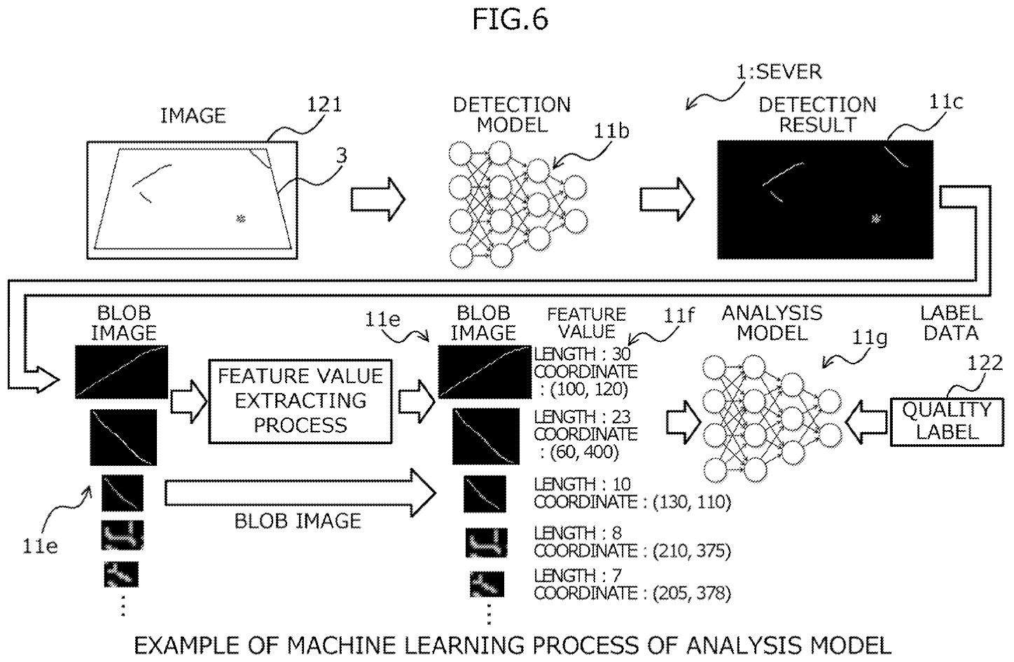

FIG. 6 is a diagram illustrating an example of the machine learning process on the analysis model 11g. As illustrated in FIG. 6, the blob extracting unit 14 inputs the image 121 included in each analysis model training data 120 into the machine-learned (trained) detection model 11b, and obtains the detection result 11c representing the defect region in the image 121. The detection result 11c may be a binary image representing a defective portion included in the image 121 as a defect region (blob region) in a manner similar to that of the annotation image 112.

The blob extracting unit 14 performs the blob extracting process on the detection result 11c. For example, the blob extracting unit 14 may extract blob images 11e including respective blobs for each blob included in the detection result 11c, and store the one or more blob images 11e into the memory unit 11. The blob image 11e is an example of a partial image, and is, for example, an image (patch image) obtained by cutting out a rectangular region including a blob region from the binary image.

The blob extracting unit 14 may be capable of adjusting (tuning) and setting the size of the blob to be cut out, the maximum value (hereinafter also referred to as “maximum number”) of the number of blobs to be cut out from one detection result 11c, and the like in accordance with the shape of each blob, the number of blobs included in the detection result 11c, and the like.

If setting the maximum value of the number of blobs to be cut out, the blob extracting unit 14 may extract blobs equal to or less than the maximum value in a descendant order of the pixel size of the blob region among multiple cut-out blobs in order to obtain a feature having a large relevance to the quality determination process. For example, the blob extracting unit 14 may sort multiple blobs in the descending order of the pixel size of a blob region.

The feature value extracting unit 15, by performing a feature value extracting process on each of one or more blob images 11e, extracts the feature value 11f from each of the one or more blob images 11e, and stores the extracted feature values 11f into the memory unit 11.

The feature value 11f is a feature value of a given type compatible with the purpose of the quality determination or the like, and may include, for example, the length of the blob and the coordinates of the blob in the image 121, as illustrated in FIG. 6. The length of the blob is an example of the longitudinal size of the blob in the image 121, and may be, for example, the number of pixels aligned in the longitudinal direction of the blob. The coordinate of a blob is an example of the position of the blob in the image 121, and may be, for example, the values of the X coordinate and the Y coordinate of the center position (or the center of gravity) of the blob. The feature value 11f is not limited to the length and the coordinate of a blob, and may alternatively be, for example, a feature value of various types such as an area of the blob, or one of the feature values or any combination of two or more of the feature values, depending on the purpose of the quality determination, for example.

The analysis model training unit 16 performs machine learning on the analysis model 11g using data included in the analysis model training data set 11d′. The analysis model 11g is an example of an evaluation model.

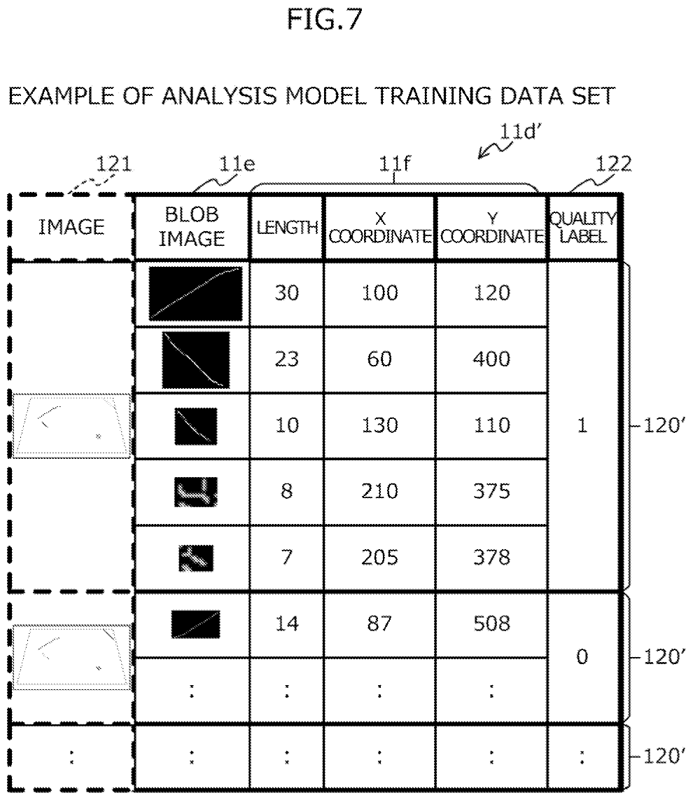

FIG. 7 is a diagram illustrating an example of an analysis model training data set 11d′ used in machine-learning the analysis model 11g. The analysis model training data set 11d′ may include analysis model training data 120′ for each photographed image (image 121) of the target 3. As illustrated in FIG. 7, the analysis model training data 120′ may include, for example, the blob images 11e extracted by the blob extracting unit 14 and the feature values 11f extracted by the feature value extracting unit 15 in association with each other in addition to the image 121 like the detection model training data set 11a and the quality labels 122. The analysis model training data set 11d′ may include no image 121.

As described above, each analysis model training data 120′ may include, for example, a pair of first data including one or more blob images 11e and one or more feature values 11f extracted from a photographed image of one target 3, and second data including a quality labels 122 serving as teaching information of the analysis model 11g.

For the sake of convenience, the following description assumes a case where the analysis model training unit 16 performs the machine learning process, using the analysis model training data set 11d′ obtained by correcting (modifying) the analysis model training data set 11d, but the present invention is not limited to this. For example, instead of generating of the analysis model training data set 11d′, the analysis model training unit 16 may use the blob images 11e and the feature values 11f stored in the memory unit 11, and the quality labels 122 in the analysis model training data set 11d.

As illustrated in FIG. 6, the analysis model training unit 16 machine-learns (trains) the AI model using a collection of the blob images 11e and the feature values 11f included in respective analysis model training data 120′ of the analysis model training data set 11d′ as inputting data and also using the quality labels 122 as the teaching information.

Incidentally, the arrangement order of multiple blob images 11e (group of patch images) does not affect the quality determination result (inspection result) of the target 3. Therefore, an AI model that can handle multiple blob images 11e as collection having unordered properties (can achieve a set operation) may be used.

For example, the analysis model training unit 16 may train the AI model by using multiple blob images 11e and multiple feature values 11f obtained from one image 121 as inputs, and also using a quality label 122 indicating final quality determination result as teaching information. The AI model becomes available as the analysis model 11g upon completion of the machine learning. In other words, the analysis model 11g is an example of a NN in which a set operation is incorporated.

As described above, the obtaining unit 12, the detection model training unit 13, the blob extracting unit 14, the feature value extracting unit 15, and the analysis model training unit 16 are examples of the machine learning unit that machine-learned the detection model 11b and the analysis model 11g in the machine learning phase.

The machine learning process on the detection model 11b by the detection model training unit 13 and the machine learning process of the analysis model 11g by the analysis model training unit 16 may adopt various known techniques.

For example, in the machine learning process, in order to reduce the value of an error function obtained on the basis of both of an estimated result obtained by a forward propagation process of the AI model according to the input and the teaching information, the backward propagation process for determining the parameters used in the process in the forward propagation process may be performed. In the machine learning process, an updating process of updating variables such as a weight on the basis of the result of the backward propagation process may be executed. These parameters, variables, and the like may be included in each of the AI models. The detection model training unit 13 and the analysis model training unit 16 may update the AI model by repeatedly executing the machine learning process on the AI model until the iteration or the accuracy reaches the threshold value. As described above, the AI model having finished the machine learning is the trained detection model 11b and the trained analysis model 11g.

In the inferring phase, the executing unit 17 executes an inferring process using the detection model 11b and the analysis model 11g.

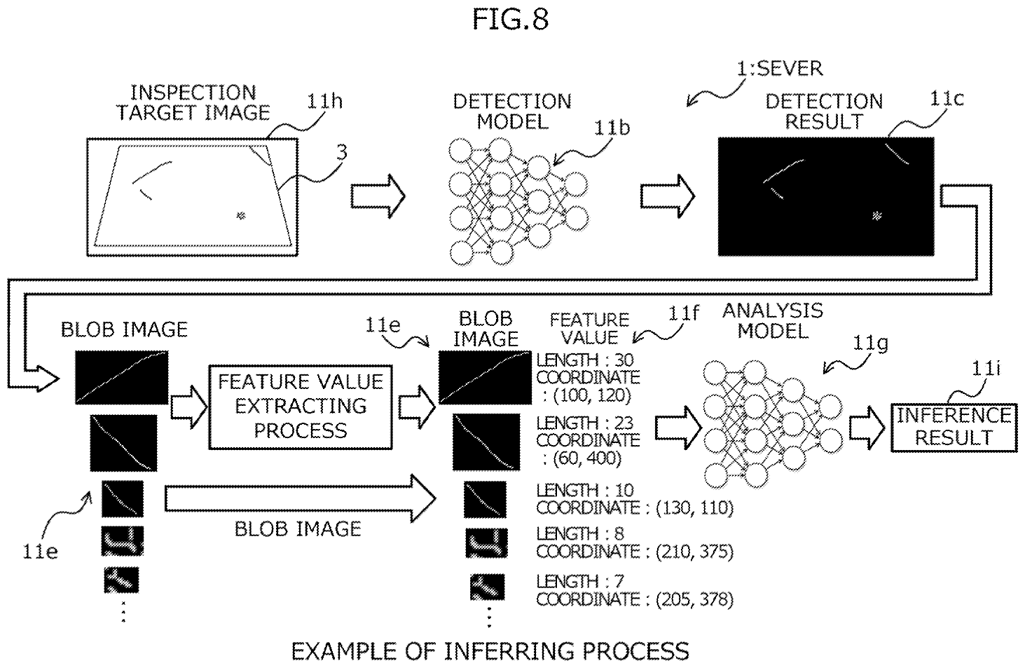

FIG. 8 is a diagram illustrating an example of the inferring process performed by the executing unit 17. For example, the executing unit 17 inputs an inspection target image 11h, which is an example of the input image data, into the detection model lib, and obtains the detection result 11c. In addition, the executing unit 17 inputs the detection result 11c into the blob extracting unit 14 to obtain (specify) multiple blob images 11e. Further, the executing unit 17 inputs multiple blob images 11e into the feature value extracting unit 15 to obtain (specify) multiple feature values 11f.

Then, the executing unit 17 evaluates the inspection target image 11h by inputting multiple blob images 11e and multiple feature values 11f obtained from the inspection target image 11h into the analysis model 11g. For example, the executing unit 17 obtains the inference result 11i as the evaluation result from the analysis model 11g.

The executing unit 17 may store at least one of the detection result 11c, multiple blob images 11e, multiple feature values 11f, and the inference result lii obtained in the course of the inferring process into the memory unit 11 in association with the inspection target image 11h.

The inference result lii is information indicating a final quality determination result of the inspection target image 11h with the analysis model 11g, in other words, the evaluation result, and may be, for example, a numeric value corresponding to a class such as “non-defective product” or “defective product”. As an example, the inference result 11i may be a likelihood expressed by a decimal number of “0” or more and “1” or less. The likelihood is the degree indicating the likelihood of a class. For example, it can be said that, in indicating the likelihood of defective products from the inference result 11i, a target expressed by the likelihood close to “1” has a higher possibility of being a defective product while a target expressed by the likelihood closer to “0” has a higher possibility of not being defective product (non-defective products).

In one embodiment, for the sake of simplicity, two classes of “non-defective” and “defective” are used as the classes of the inference result 11i, but the number of determination types (the number of classes) in the inferring process may be changed (e.g., increased) appropriately in accordance with the task.

The outputting unit 18 outputs the inference result 11i obtained by the executing unit 17 as output data. For example, the outputting unit 18 may transmit the inference result 11i itself to non-illustrated another computer, or may accumulate the inference results 11i in the memory unit 11 and manage the results referable from the server 1 or another computer. Alternatively, the outputting unit 18 may output information representing the inference result 11i to a screen of an output device of, for example, the server 1.

The outputting unit 18 may output various data as output data in place of or in addition to the inference result 11i per se. The output data may be various data such as an analysis result on a quality determination result based on the inference result 11i, the intermediate generation information (e.g., the blob images 11e, the feature values 11f) itself, or an analysis result on the basis of the quality determination based on the intermediate generation information. The analysis result on the basis of the quality determination may be, for example, regarded as the manifestation of so-called “implicit knowledge” for informing the user of how the AI model makes the determination.

As described above, the obtaining unit 12, the blob extracting unit 14, the feature value extracting unit 15, the executing unit 17, and the outputting unit 18 are examples of the inferring processing unit that executes the quality determination process of the target 3 by using the trained detection model 11b and the trained analysis model 11g in the inferring phase. The inferring processing unit may output the obtained inference result 11i as a quality determination result.

### (1-2) Example of Operation

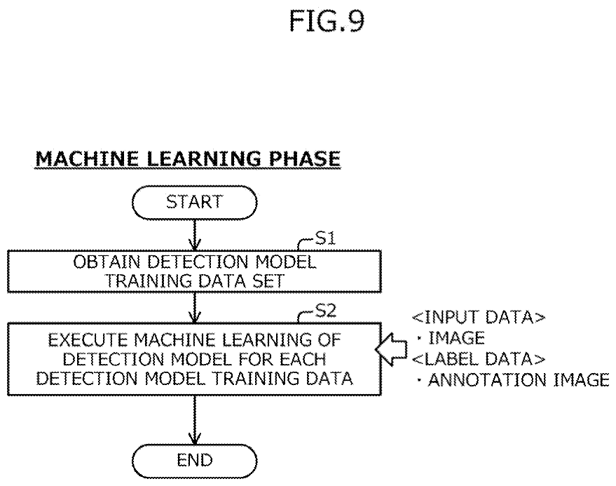

Next, example of operations of the server 1 configured as described above will be described with reference to FIGS. 9 to 12.

### (1-2-1) Example of Operation of Machine Learning Phase

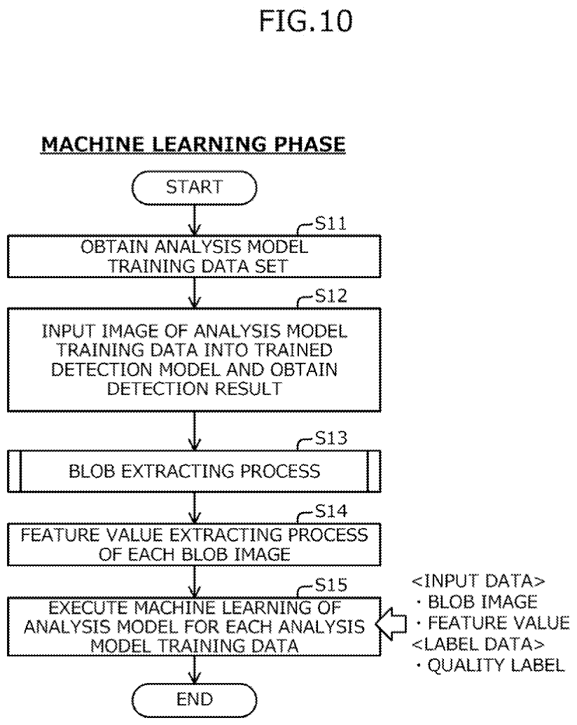

FIG. 9 is a flow diagram illustrating an example of an operation of the machine learning process of the detection model 11b, and FIG. 10 is a flow diagram illustrating an example of an operation of the machine learning process of the analysis model 11g.

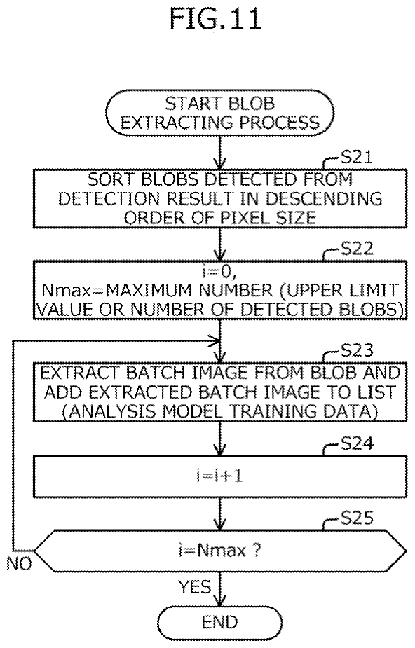

FIG. 11 is a flow diagram illustrating an example of an operation of the blob extracting process. The machine learning process of the analysis model 11g may be executed after the machine learning process of the detection model 11b is completed.

(Machine Learning Process of Detection Model 11b)

As illustrated in FIG. 9, the obtaining unit 12 obtains the detection model training data set 11a (Step S1) and stores the detection model training data set 11a into the memory unit 11.

The detection model training unit 13 machine-learns the detection model 11b using the image 111 as input data and the annotation image 112 as label data for each detection model training data 110 in the detection model training data set 11a (Step S2), and ends the processing. For example, each annotation image 112 may be a binary image indicating a defect region in the corresponding image 111.

(Machine Learning Process of Analysis Model 11g)

As illustrated in FIG. 10, the obtaining unit 12 obtains the analysis model training data set 11d (Step S11) and stores the analysis model training data set 11d into the memory unit 11.

The blob extracting unit 14 inputs the images 121 of the analysis model training data 120 in the analysis model training data set 11d into the machine-learned detection model lib, obtains the detection result 11c from the detection model 11b (Step S12), and stores the detection result 11c into the memory unit 11. The detection result 11c may be a binary image indicating a defect region in each image 121.

The blob extracting unit 14 executes a blob extracting process on the basis of the detection result 11c (Step S13).

The feature value extracting unit 15 performs a feature value extracting process on each of multiple blob images 11e obtained in the blob extracting process (Step S14), extracts the feature value 11f from each blob image 11e, and stores the feature values 11f into the memory unit 11.

The analysis model training unit 16 machine-learns the analysis model 11g for each analysis model training data 120′ in the analysis model training data set 11d′ including the blob images 11e and the feature values 11f (Step S15), and then the process ends. In the machine learning, the analysis model training unit 16 may train the analysis model 11g by using multiple blob images 11e and multiple feature values 11f corresponding to the image 121 of one target 3 as inputting data, and using the quality labels 122 corresponding to the image 121 as label data.

(Blob Extracting Process)

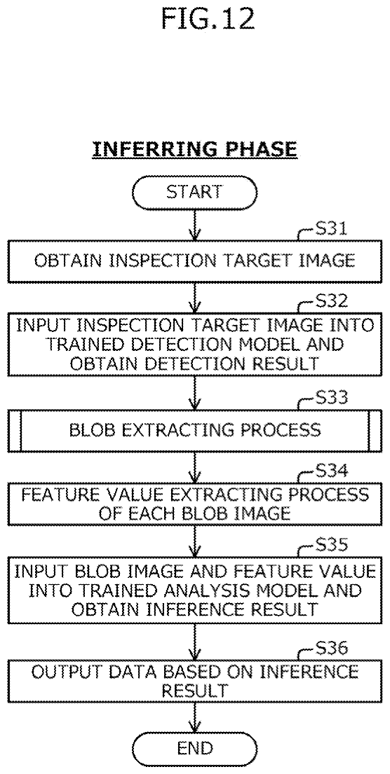

As illustrated in FIG. 11, in the blob extracting process (Step S13 in FIG. 10 or Step S33 in FIG. 12 described below), the blob extracting unit 14 sorts the blobs extracted from the detection result 11c in the descending order of pixel size thereof (Step S21).

The blob extracting unit 14 sets “zero” in the variable i, for example, and sets the maximum number in the Nmax (Step S22). The maximum number may be, for example, a predetermined upper limit value, or may be the number of blobs detected in Step S21.

The blob extracting unit 14 cuts out (extracts) a blob as a patch image (blob image 11e), adds it to a list, for example, the analysis model training data 120′ (Step S23), and adds one to i (Step S24).

The blob extracting unit 14 determines whether or not i has reached Nmax (Step S25), and if it has not reached (NO in Step S25), the process proceeds to Step S23. On the other hand, when i has reached Nmax (YES in Step S25), the blob extracting process ends.

### (1-2-2) Example of Operation of Inferring (Determining) Phase

FIG. 12 is a flow diagram illustrating an example of an operation of the inferring process. As illustrated in FIG. 12, the obtaining unit 12 obtains the inspection target image 11h (Step S31), and stores the inspection target image 11h into the memory unit 11.

The executing unit 17 inputs the inspection target image 11h into the machine-learned detection model 11b, obtains the detection result 11c from the detection model 11b (Step S32), and stores the detection result 11c into the memory unit 11. The detection result 11c may be a binary image indicating a defect region in the inspection target image 11h.

The executing unit 17 inputs the detection result 11c into the blob extracting unit 14, executes the blob extracting process illustrated in FIG. 11 (Step S33), and obtains multiple blob images 11e.

The executing unit 17 inputs multiple blob images 11e obtained in the blob extracting process into the feature value extracting unit 15, and executes the feature value extracting process for each blob image 11e (Step S34). The executing unit 17 obtains multiple feature values 11f by the feature value extracting process, and stores the obtained feature values 11f into the memory unit 11.

The executing unit 17 inputs the multiple blob images 11e and the multiple feature values 11f into the machine-learned analysis model 11g, and thereby obtains the inference result 11i (Step S35).

The outputting unit 18 outputs the outputting data based on the inference result 11i (Step S36), and the process ends. For example, the outputting unit 18 may output the inference result 11i as the outputting data, or may generate and output various outputting data based on the inference result 11i.

### (1-3) Description of One Embodiment

Next, the server 1 according to the one embodiment described above will now be described along with an application example.

(Variations of Defects to be Target of Quality Determination)

The server 1 of the one embodiment can accomplish quality determination on the target 3 in relation to various defects that the target 3 may have.

For example, a defect detected as a blob region (defect region) may be exemplified by the following items, depending on the type of the target 3.

In the cases where the target 3 is a glass plate 33, examples of the defect are a scratch, a foreign matter such as dust contaminated in the target 3, bubble, and a crack. A crack may include cleft or alligatoring.

In the case where the target 3 is a substrate 31, example of the defect are a scratch, a crack, a crazing, a measling, and a soldering defect. Crazing is that glass fibers are peeled from the resin by mechanical stress, and measling is that glass fibers are peeled from the resin mainly by heat stress.

In the case where the target 3 is a sheet 32, examples of the defect are a scratch, a wrinkle, a streak, and a fisheye. A streaks is a defect that generates streaky marks in silver foil color due to gas appearing on the surface, and a fisheye is a spherical blob made of a portion of the material that does not mix completely with the surrounding material.

In the case where the target 3 is cans 35, examples of a defect are a scratch, a dent, and an oil stain.

The above-mentioned various defects may be detected in a binary form by the detection model 11b, for example, as a long thin line for a scratches, or as a dense of a small blobs for a foreign matter such as dust. In this manner, the blob regions may be represented as having at least one of the size, shape, number, and the like of the blobs different from each other depending on the type of defect.

The server 1 according to the one embodiment can extract an arbitrary (for example, a desired value set by a user) feature value 11f because a patch image (blob image lie) is cut out in units of a blob from an output image (detection result 11c) of the detection model lib.

### First Example

For example, in cases where the blob image 11e related to a thin-line scratch is used for the quality determination, the server 1 may extract the length of a blob as the feature value 11f. As a result, the server 1 can machine-learns the analysis model 11g, distinguishing blobs to be used for the quality determination from defects except for a scratch and blobs not contributing to the quality determination. In addition, the server 1 can output an inference result 11i based on a blob related to a thin-line scratch using the machine-learned analysis model 11g.

### Second Example

In cases where a cosmetic change of the target 3 due to contamination of foreign matter such as dust is used for quality determination, the defect may sometimes looks like a dense of multiple small blobs on the photographed image 21. In this case, the server 1 may extract the position coordinates of each blob as the feature value 11f. This allows the server 1 to machine-learn the analysis model 11g, considering the density of the blobs. In addition, the server 1 can make a determination, considering the density of blobs by using the machine-learned analysis model 11g.

### Third Example

In cases where the blob images 11e related to crazing and measling on the substrate 31 such as a printed circuit board are used for the quality determination, a defect region with crazing and measling looks in a different colors from the remaining region on the photographed image 21. In this case, the server 1 may perform a mask process on the inputting image exemplified by the image 121 and the inspection target image 11h using the detection result 11c of the detection model 11b as a mask image, for example. Then, the server 1 may divide the image obtained by the mask process for each blob to obtain partial images (blob images 11e). As a result, it is possible to perform the quality determination process after color information is added to the blob images 11e.

### Fourth Example

A fisheye generated on the sheet 32 have a spherical blob shape. Therefore, when the blob images 11e related to a fisheye are used for the quality determination, the server 1 extracts the information such as the major axis, the minor axis, and the circumference of the blob as the feature values 11f and then machine learns the analysis model 11g using the extracted feature values 11f, so that the logic that uses whether or not a blob shape (feature values 11f) is close to a circular shape as the determination material can be incorporated into the analysis model 11g.

### Fifth Example

In determination of a soldering defect of the substrate 31, the server 1 extracts the area of each blob as the feature value 11f and then machine learns the analysis model 11g using the extracted feature values 11f, so that the logic that uses whether the amount of the solder is larger or smaller than the criterion as the determination material can be incorporated into the analysis model 11g.

(Description of Set Operation)

The server 1 according to the one embodiment can effectively process characteristics of multiple unordered blobs obtained from one inspection target image 11h by the set operation using the analysis model 11g.

Since a set operation can grasp not only the characteristics of the individual blob but also the broad features of the entire photographed image 21, even in cases where the quality determination result changes with the degree of defect in the overall component or product, machine learning and inference to which the server 1 is applied becomes possible. As an example, the server 1 can be applied to the one embodiment even when the number of a certain type of defect that determines a component or product to be defective is the implicitly known.

In addition, the server 1 can mitigate the influence of the difference between the size of the input image (photographed image 21) and the size of each blob by performing the set operation. In other words, even when the photographed image 21 is a high-resolution image and the size of the defect becomes extremely small with respect to the image size, the quality determination can be appropriately accomplished.

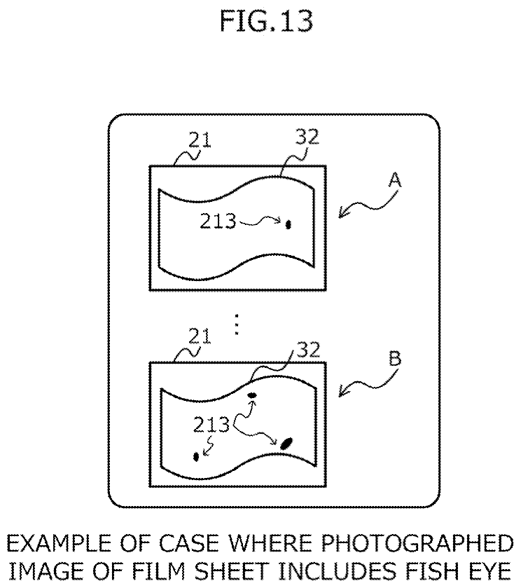

FIG. 13 is a diagram illustrating an example of a case where a defect of a fisheye 213 is included in a photographed image 21 of a sheet 32 exemplified by a film sheet.

For the photographed image 21 illustrated by Arrow A in FIG. 13, when the number of fisheyes 213 is small and the degree thereof is low (e.g., the size is small), the server 1 can treat the defect as a harmless defect (in other words, a non-defective product) in the inference by the analysis model 11g.

On the other hand, for the photographed image 21 illustrated by Arrow B in FIG. 13, when the number of fisheyes 213 is large and a relatively large defect is observed, the server 1 can determine the defect as a defective product in the inference by the analysis model 11g. As described above, the server 1 can cause the analysis model 11g to obtain the criteria and boundaries of the quality determination by the machine learning of the AI model, instead of the rule base, for example, that if the photographed image 21 includes a certain number or more of fisheyes 213, the component or product is determined to be defective.

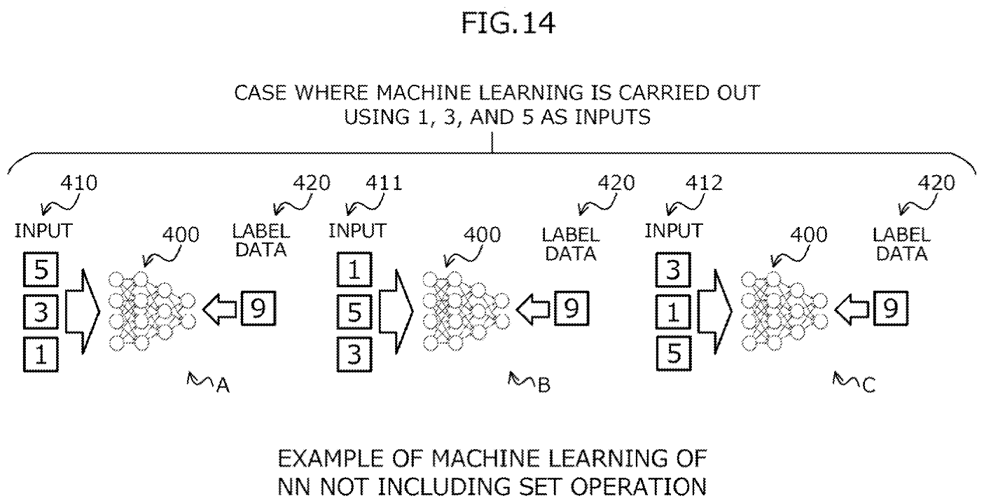

FIG. 14 is a diagram exemplifying machine-learning of a NN 400 not including a set operation. As illustrated in FIG. 14, when the NN 400 including no set operation is machine-learned by using “1”, “3” and “5” as inputting information, the same data is input into the NN 400 by as indicated by Arrows A-C and inputting the reordered same data into the NN 400. For example, the input 410 is arranged in the order of “5”, “3”, and “1” in the Arrow A, the input 411 is in the order of “1”, “5”, and “3” in the Arrow B, and the input 412 is arranged in the order of “5”, “3”, and “1” in the Arrow C. The teaching information 420 is common to the Arrows A to C.

As exemplified in FIG. 14, in a typical NN such as the NN 400, the inference result changes with the order of arrangement of the feature values to be inputted, and therefore, as exemplified in FIG. 14, machine-learning is performed by considering combinations of arrangement order. Repeating machine learning of the NN 400 using the same data as inputs over the number of combinations of arrangement order of data increases the time for machine learning of the NN 400. In addition, the characteristic that the output from the NN 400 changes when the arrangement order of the data is changed is inappropriate for the quality determination on the premise that the size, number, position, and the like of the blobs in the photographed image 21 are indefinite.

On the other hand, according to the server 1 of the one embodiment, by incorporating set operation into the NN (analysis model 11g), it is possible to eliminate the need to consider the arrangement order of multiple blob images 11e and the arrangement order of multiple feature values 11f input into the analysis model 11g. Therefore, as compared with the example of FIG. 14, the machine learning time can be reduced. In addition, it is possible to make an appropriate quality determination irrespective of the arrangement order of the data.

### Example of Outputting Data

Next, an example of outputting data output from the server 1 (outputting unit 18) according to the one embodiment will now be described. As described above, the outputting unit 18 may output, as the outputting data, intermediate generation information itself or the analysis result of the basis of the quality determination based on the intermediate generation information in place of or in addition to the inference result 11i.

For example, the outputting unit 18 or the computer that has obtained the intermediate generation information can analyze the basis of the determination of the server 1 (quality determining system) on the basis of the blob images 11e obtained as the intermediate generation information and the feature values 11f calculated from the blob images 11e.

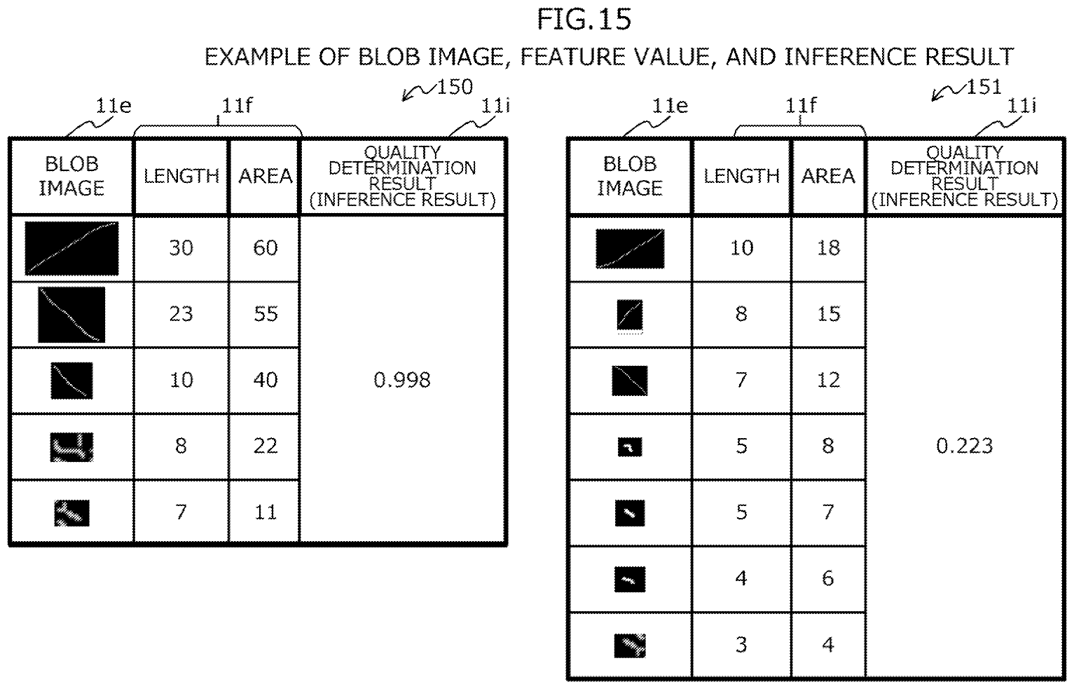

FIG. 15 is a diagram illustrating an example of the blob images 11e, the feature values 11f, and the inference results 11i (quality determination results). For example, the outputting unit 18 may output data (i.e., outputting data 150 and 151) illustrated in FIG. 15. In the example of FIG. 15, the quality determination result (inference result 11i) is the likelihood of a defective product, and the result closer to “1” is more likely to be a defective product while the result closer to “0” is more likely to be a non-defective product.

With reference to examples of the quality determination result of the outputting data 150 and 151, it is understood that the presence of a blobs each having a larger length or size in the detected blobs is more easily adopted as the basis for determining a defective product than the presence of the larger number of blobs. As the above, the output of the outputting data 150 and 151 containing (or being based on) the intermediate generation information makes it possible to more quantitatively evaluate the characteristics of the system of the server 1.

### Effect of the One Embodiment

As described above, the server 1 according to the one embodiment specifies multiple blob images 11e included in the inspection target image 11h (for example, through the blob extracting process) by inputting the inspection target image 11h into the analysis model 11g trained with the detection model training data 110. Further, the server 1 evaluates the inspection target image 11h by inputting the multiple specified blob images 11e into the analysis model 11g trained with the analysis model training data 120′. As a result, the accuracy of the evaluation of the target 3 by using the inspection target images 11h can be enhanced.

For example, by the blob extracting unit 14 individually cutting out multiple blob images 11e from the detection result 11c, the influence on the determination accuracy according to the resolution of the photographed image 21 can be mitigated.

In addition, using the NN having a collection serving as an input as the analysis model 11g makes it possible to achieve inference considering the size, the shape, the number, and the like of the blobs without being influenced with the order of the detected blobs, so that the quality determination can be accomplished highly precisely.

Further, instead of performing the quality determination for each blob, using the multiple blobs as inputs into the analysis model 11g makes it possible to perform the quality determination based on the photographed image 21 (the inspection target image 11h) in unit of the target 3 such as a component or product.

In addition, since at least one of the blob images 11e and the feature values 11f can be obtained as the intermediate generation information, it is possible to analyze the basis of the quality determination.

Further, since the analysis model 11g is caused to execute the quality determination based on the blob images 11e and the feature values 11f after performing the predetermined feature value extracting process on the blobs, an AI having a property suitable for the needs of the user can be easily developed.

In addition, the server 1 can accomplish the quality determination on a component or a product, considering the size, shape, number, and the like of the blobs, the purpose and the requirements of the inspection, and the like by tuning of feature value extracting according to the characteristics of the blob, in other words, extracting of the type according to the purpose of the quality determination or the like. The feature values of the type according to the purpose of the quality determination or the like can be selected by the user so that appropriate quality determination can be flexibly made according to the target 3 or the like.

### (1-4) Example of Hardware Configuration

The apparatus that achieves the server 1 according to the one embodiment may be a virtual server (VM; Virtual Machine), or a physical server. The function of the server 1 may be achieved by a single computer or two or more computers. Further, part of the function of the server 1 may be achieved by a Hardware (HW) resource and a network (NW) resource that are provided in the cloud environment.

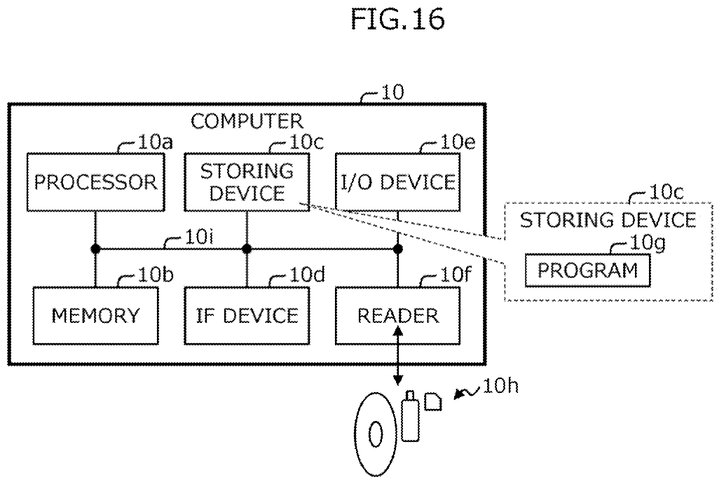

FIG. 16 is a block diagram illustrating an example of the hardware (HW) configuration of the computer 10 that achieves the function of the server 1 of the one embodiment. When multiple computers are used as the HW resource that achieves the function of the server 1, each of the computers may have the HW configuration illustrated in FIG. 16.

As illustrated in FIG. 16, the computer 10 may exemplarily include a processor 10a, a memory 10b, a storing device 10c, an IF (Interface) device 10d, an I/O (Input/Output) device 10e, and a reader 10f as the HW configuration.

The processor 10a is an example of an arithmetic processing apparatus that performs various controls and arithmetic operations. The processor 10a may be communicably connected to the blocks in the computer 10 to each other via a bus 10i. The processor 10a may be a multiprocessor including multiple processors, a multi-core processor including multiple processor cores, or a configuration including multiple multi-core processors.

An example of the processor 10a is an Integrated Circuit (IC) such as a Central Processing Unit (CPU), a Micro Processing Unit (MPU), a Graphics Processing Unit (GPU), an Accelerated Processing Unit (APU), a Digital Signal Processor (DSP), an Application Specific IC (ASIC), and a Field-Programmable Gate Array (FPGA). Alternatively, the processor 10a may be a combination of two or more ICs exemplified as the above.

The memory 10b is an example of a HW device that stores information such as various data pieces and a program. An example of the memory 10b includes one or both of a volatile memory such as the Dynamic Random Access Memory (DRAM) and a non-volatile memory such as the Persistent Memory (PM).

The storing device 10c is an example of a HW device that stores information such as various data pieces and programs. Examples of the storing device 10c is various storing devices exemplified by a magnetic disk device such as a Hard Disk Drive (HDD), a semiconductor drive device such as an Solid State Drive (SSD), and a non-volatile memory. Examples of a non-volatile memory are a flash memory, a Storage Class Memory (SCM), and a Read Only Memory (ROM).

The information 11a to 11i that the memory unit 11 stores as illustrated in FIG. 1 may each be stored in one or the both of storing regions of the memory 10b and the storing device 10c.

The storing device 10c may store a program 10g (evaluating program) that achieves the overall or part of the function of the computer 10. For example, the processor 10a of the server 1 can achieve the function of the server 1 (e.g., the controlling unit 19) illustrated in FIG. 1 by expanding the program 10g stored in the storing device 10c onto the memory 10b and executing the expanded program 10g.

The IF device 10d is an example of a communication IF that controls connection to and communication with a network between the computer 10 and another apparatus. For example, the IF device 10d may include an adaptor compatible with a Local Area Network (LAN) such as Ethernet (registered trademark) and an optical communication such as Fibre Channel (FC). The adaptor may be compatible with one of or both of wired and wireless communication schemes. For example, the server 1 may be communicably connected to a non-illustrated computer via the IF device 10d. Further, the program 10g may be downloaded from a network to a computer 10 through the communication IF and then stored into the storing device 10c, for example.

The I/O device 10e may include one of or both of an input device and an output device. Examples of the input device are a keyboard, a mouse, and a touch screen. Examples of the output device are a monitor, a projector, and a printer.

The reader 10f is an example of a reader that reads information of data and programs recorded on a recording medium 10h. The reader 10f may include a connecting terminal or a device to which the recording medium 10h can be connected or inserted. Examples of the reader 10f include an adapter conforming to, for example, Universal Serial Bus (USB), a drive apparatus that accesses a recording disk, and a card reader that accesses a flash memory such as an SD card. The program 10g may be stored in the recording medium 10h. The reader 10f may read the program 10g from the recording medium 10h and store the read program 10g into the storing device 10c.

An example of the recording medium 10h is a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the computer 10 described above is merely illustrative. Accordingly, the computer 10 may appropriately undergo increase or decrease of HW (e.g., addition or deletion of arbitrary blocks), division, integration in an arbitrary combination, and addition or deletion of the bus. For example, at least one of the I/O device 10e and the reader 10f may be omitted in the server 1.

### (2) Miscellaneous

The technique according to the one embodiment described above can be modified and implemented as follows.

For example, each of the processing functions 12 to 18 included in the server 1 of FIG. 1 may be merged and may be divided respectively.

In addition, the server 1 may be allowed to have a configuration not including the feature value extracting unit 15. In other words, the server 1 may omit the obtaining of the feature values 11f from the blob images 11e in the machine learning of the analysis model 11g and inferring, and may input the blob image 11e as input information into the analysis model 11g.

Furthermore, in the one embodiment, the photographed images 21 (images 111, 121 and the inspection target image 11h) are assumed to be images photographed by the camera 2 having an image sensor for capturing visible light, but are not limited thereto. Alternatively, the photographed images 21 may be various images such as ultrasonic images, magnetic resonance images, X-ray images, an image photographed by a sensor that captures for temperature or an electromagnetic wave, and a photographed image by an image sensor for capturing non-visible light.

The server 1 illustrated in FIG. 1 may have a configuration that achieves each processing function by multiple apparatuses cooperating with each other via a network. For example, the obtaining unit 12 and the outputting unit 18 may be a web server; the detection model training unit 13, the blob extracting unit 14, the feature value extracting unit 15, the analysis model training unit 16, and the executing unit 17 may be an application server; and the memory unit 11 may be a Database (DB) server. In this case, each processing function as the server 1 may be achieved by the web server, the application server, and the DB server cooperating with one another via a network.

Further, the respective processing functions relating to the machine learning process by the detection model training unit 13 and the analysis model training unit 16 and the inferring process by the executing unit 17 may be provided by different apparatuses. Also in this case, these apparatuses may cooperate with each other via a network to achieve each processing function as the server 1.

As one aspect, it is possible to enhance the precision in evaluation made on a target with images.

Throughout the description, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein an evaluation program for causing a computer to execute a process comprising:
specifying a plurality of partial images included in input image data by inputting the input image data into a detection model, the detection model being a machine learning model trained with a first training data set including a plurality of first training data each associating image data with a partial image which contains an extraction target from the image data; and
evaluating the input image data by inputting the plurality of specified partial images into an evaluation model, the evaluation model being a machine learning model trained with a second training data set including a plurality of second training data each associating one or more partial images with an evaluation result of a target being a subject of an image containing the one or more partial images.

2. The non-transitory computer-readable recording medium according to claim 1, wherein
each of the plurality of second training data includes one or more feature values of a given type, the one or more feature values being obtained from the one or more partial images; and
the evaluating of the input image data comprises inputting, into the evaluation model, the plurality of specified partial images and a plurality of obtained feature values of the given type, the plurality of obtained feature values being obtained from the plurality of specified partial images.

3. The non-transitory computer-readable recording medium according to claim 2, wherein the plurality of obtained feature values include at least one of a length, an area, and a coordinate of a region of the extraction target contained in each of the plurality of specified partial images according to a purpose of the evaluating, the coordinate representing a coordinate when the region is adopted to the input image data.

4. The non-transitory computer-readable recording medium according to claim 1, wherein the process further comprises outputting a result of the evaluating and the plurality of specified partial images.

5. The non-transitory computer-readable recording medium according to claim 1, wherein the evaluation model is a neural network incorporated therein a set operation.

6. The non-transitory computer-readable recording medium according to claim 2, wherein each of the plurality of second training data includes the one or more partial images and one or more feature values of a given type obtained from the one or more partial images as input data and a result of evaluating as label data.

7. An evaluation method executed by a computer, the evaluation method comprising:
specifying a plurality of partial images included in input image data by inputting the input image data into a detection model, the detection model being a machine learning model trained with a first training data set including a plurality of first training data each associating image data with a partial image which contains an extraction target from the image data; and
evaluating the input image data by inputting the plurality of specified partial images into an evaluation model, the evaluation model being a machine learning model trained with a second training data set including a plurality of second training data each associating one or more partial images with an evaluation result of a target being a subject of an image containing the one or more partial images.

8. The evaluation method according to claim 7, wherein
each of the plurality of second training data includes one or more feature values of a given type, the one or more feature values being obtained from the one or more partial images; and
the evaluating of the input image data comprises inputting, into the evaluation model, the plurality of specified partial images and a plurality of obtained feature values of the given type, the plurality of obtained feature values being obtained from the plurality of specified partial images.

9. The evaluation method according to claim 8, wherein the plurality of obtained feature values include at least one of a length, an area, and a coordinate of a region of the extraction target contained in each of the plurality of specified partial images according to a purpose of the evaluating, the coordinate representing a coordinate when the region is adopted to the input image data.

10. The evaluation method according to claim 7, further comprising outputting a result of the evaluating and the plurality of specified partial images.

11. The evaluation method according to claim 7, wherein the evaluation model is a neural network incorporated therein a set operation.

12. The evaluation method according to claim 8, wherein each of the plurality of second training data includes the one or more partial images and one or more feature values of a given type obtained from the one or more partial images as input data and a result of evaluating as label data.

13. An information processing apparatus comprising:
a memory;
a processor coupled to the memory, the processor being configured to:
specify a plurality of partial images included in input image data by inputting the input image data into a detection model, the detection model being a machine learning model trained with a first training data set including a plurality of first training data each associating image data with a partial image which contains an extraction target from the image data; and
evaluate the input image data by inputting the plurality of specified partial images into an evaluation model, the evaluation model being a machine learning model trained with a second training data set including a plurality of second training data each associating one or more partial images with an evaluation result of a target being a subject of an image containing the one or more partial images.

14. The information processing apparatus according to claim 13, wherein
each of the plurality of second training data includes one or more feature values of a given type, the one or more feature values being obtained from the one or more partial images; and
the processor evaluates the input image data by inputting, into the evaluation model, the plurality of specified partial images and a plurality of obtained feature values of the given type, the plurality of obtained feature values being obtained from the plurality of specified partial images.

15. The information processing apparatus according to claim 14, wherein the plurality of obtained feature values include at least one of a length, an area, and a coordinate of a region of the extraction target contained in each of the plurality of specified partial images according to a purpose of the evaluating, the coordinate representing a coordinate when the region is adopted to the input image data.

16. The information processing apparatus according to claim 13, wherein the processor further outputs a result of the evaluating and the plurality of specified partial images.

17. The information processing apparatus according to claim 13, wherein the evaluation model is a neural network incorporated therein a set operation.

18. The information processing apparatus according to claim 14, wherein each of the plurality of second training data includes the one or more partial images and one or more feature values of a given type obtained from the one or more partial images as input data and a result of evaluating as label data.
